(19) United States
(12) Patent Application Publication
(10) Pub. No.: US 2026/0362032 A1
(43) Pub. Date: Nov. 12, 2026

(54) IMAGING DEVICE

(71) Applicant: Sharp Semiconductor Innovation Corporation, Tenri City (JP)

(72) Inventors: Nobuhisa SAKAGUCHI, Tenri City (JP); Norikazu MURAKI, Tenri City (JP); Ken SUMITANI, Tenri City (JP); Manabu YAMAMOTO, Tenri City (JP)

(21) Appl. No.: 19/539,346

(22) Filed: Feb. 13, 2026

(30) Foreign Application Priority Data
May 8, 2025 (JP) 2025-078025

(51) Int. Cl. H04N 25/633; H04N 25/702

(52) U.S. Cl. CPC H04N 25/633; H04N 25/702

(57) ABSTRACT

An imaging device includes: first to n-th rows; first to n-th readout circuits configured to read analog effective pixel signals in the first to n-th rows, respectively, from the effective pixels belonging to the first to n-th rows, read analog optical black pixel signals in the first to n-th rows, respectively, from the optical black pixels belonging to the first to n-th rows, convert the analog effective pixel signals in the first to n-th rows into digital effective pixel signals in the first to n-th rows, and convert the analog optical black pixel signals in the first to n-th rows into digital optical black pixel signals in the first to n-th rows, respectively; and a correction circuit configured to correct the digital effective pixel signal in each of the first to n-th rows by using the digital optical black pixel signals in the first to n-th rows.

### CROSS-REFERENCE TO RELATED APPLICATION

The present application claims priority from Japanese Application JP2025-078025, the content of which is hereby incorporated by reference into this application.

### BACKGROUND OF THE INVENTION

### 1. Field of the Invention

The present disclosure relates to an imaging device.

Japanese Unexamined Patent Application Publication No. 2008-288816 discloses a solid-state imaging device.

In the solid-state imaging device, a pixel unit has effective pixels and horizontal OB pixels. A corrected horizontal OB value is produced by correcting the average value of the OB pixel values of the horizontal OB pixels. The digital pixel value of the effective pixels are corrected based on the produced corrected horizontal OB value, and the corrected digital pixel values are output (paragraphs 0045, 0049, and 0050).

### SUMMARY OF THE INVENTION

In the solid-state imaging device disclosed in Japanese Unexamined Patent Application Publication No. 2008-288816, the number of horizontal OB pixels has to be set at a certain number or more in order to appropriately correct the digital pixel value of the effective pixels. This is an obstacle to both of the enhancement of imaging quality and the reduction of the area occupied by the pixel unit.

One aspect of the present disclosure has been made in view of this problem. It is an object of one aspect of the present disclosure to provide an imaging device that can achieve, for instance, both of the enhancement of the imaging quality and the reduction of the area occupied by the pixel unit.

An imaging device according to one aspect of the present disclosure includes the following: first to n-th rows each including an effective pixel and an optical black pixel; first to n-th readout circuits configured to read analog effective pixel signals in the first to n-th rows, respectively, from the effective pixels belonging to the first to n-th rows, read analog optical black pixel signals in the first to n-th rows, respectively, from the optical black pixels belonging to the first to n-th rows, convert the analog effective pixel signals in the first to n-th rows into digital effective pixel signals in the first to n-th rows, and convert the analog optical black pixel signals in the first to n-th rows into digital optical black pixel signals in the first to n-th rows, respectively; and a correction circuit configured to correct the digital effective pixel signal in each of the first to n-th rows by using the digital optical black pixel signals in the first to n-th rows.

### BRIEF DESCRIPTION OF THE DRAWINGS

FIG. 1 is a block diagram of an imaging device according to a first embodiment;

FIG. 2 is a block diagram of columns, vertical signal line groups, and readout circuits provided in the imaging device according to the first embodiment;

FIG. 3 is a schematic plan view of a p × q number of pixels provided in the imaging device according to the first embodiment;

FIG. 4 is a timing chart showing the waveform of analog signal voltage read by each readout circuit, which is provided in the imaging device according to the first embodiment, the waveform of ramp voltage input to the readout circuit, and clocks counted by the readout circuit;

FIG. 5 is a diagram illustrating analog effective pixel signals, analog optical black (OB) pixel signals, digital effective pixel signals, and digital OB pixel signals that are processed by the imaging device according to the first embodiment;

FIG. 6 is a timing chart showing the voltage of analog signal voltage read by each readout circuit, which is provided in the imaging device according to the first embodiment, the actual waveform of ramp voltage input to the readout circuit, and clocks counted by the readout circuit;

FIG. 7 is a timing chart showing the waveform of analog signal voltage read by each readout circuit, which is provided in the imaging device according to the first embodiment, the waveforms of three kinds of ramp voltage that can be input to the readout circuit, and clocks counted by the readout circuit;

FIG. 8 is a diagram illustrating an example correction made by a correction circuit provided in the imaging device according to the first embodiment;

FIG. 9 is a block diagram of first to n-th rows and a storage memory provided in the imaging device according to the first embodiment;

FIG. 10 is a diagram of a storage memory provided in an imaging device according to a reference example, and of digital effective pixel signals and digital OB pixel signals that are transferred by a transfer circuit provided in the imaging device; and

FIG. 11 is a diagram of the storage memory provided in the imaging device according to the first embodiment, and of the digital effective pixel signals and digital OB pixel signals that are transferred by a transfer circuit provided in the imaging device.

### DETAILED DESCRIPTION OF THE INVENTION

An embodiment of the present disclosure will be described with reference to the drawings. It is noted that identical or equivalent elements will be denoted by the same signs throughout the drawings, and the description of redundancies will be omitted.

### 1 First Embodiment

### 1.1 Imaging Device

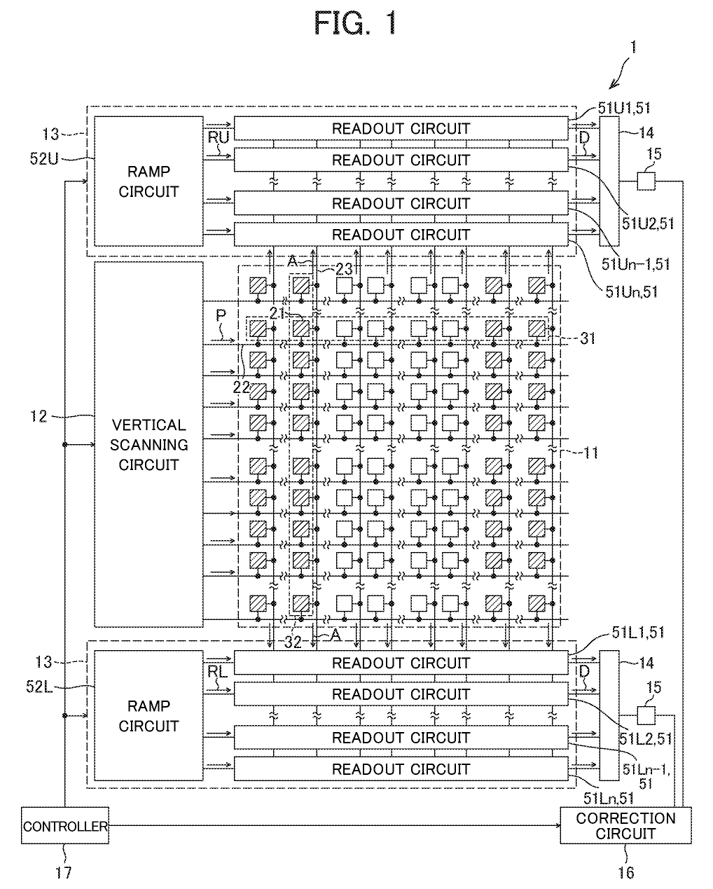

FIG. 1 is a block diagram of an imaging device according to a first embodiment.

The imaging device 1 according to the first embodiment illustrated in FIG. 1 captures an image and outputs an image signal corresponding to the captured image. The imaging device 1 is a solid-state imaging device. This solid-state imaging device is a complementary metal-oxide semiconductor (CMOS) image sensor. The technique that will be described below may be employed in imaging devices other than CMOS image sensors.

As illustrated in FIG. 1, the imaging device 1 includes a pixel unit 11, a vertical scanning circuit 12, an analog-to-digital conversion circuit 13, a storage memory 14, a transfer circuit 15, a correction circuit 16, and a controller 17.

As illustrated in FIG. 1, the pixel unit 11 includes a p × q number of pixels 21, a p number of row selection lines 22, and a q number of vertical signal line groups 23.

The p × q number of pixels 21 are arranged in rows and columns. The p × q number of pixels 21 thus constitute a pixel array of p rows and q columns. The p × q number of pixels 21 thus include a p number of rows 31 and a q number of columns 32. Each row 31 included in the p number of rows 31 is also called, but not limited to, a V-line, a row line, or a horizontal line. Each column 32 included in the q number of columns 32 is also called, but not limited to, an H-line, a column line, or a vertical line. A q number of pixels 21 belong to each row 31. A p number of pixels 21 belong to each column 32. Each pixel 21 included in the p × q number of pixels 21 includes a photodiode. The photodiode receives light, generates electric charges corresponding to the intensity of the received light, and accumulates the generated electric charges. Each pixel 21 discharges the accumulated electric charges upon receiving a row selection pulse P.

The p number of row selection lines 22 correspond one-to-one to the p number of rows 31. Each row selection line 22 included in the p number of row selection lines 22 is electrically connected to the vertical scanning circuit 12 and electrically connected to the q number of pixels 21 belonging to the row 31 to which the row selection line 22 corresponds. Each row selection line 22 thus transmits the row selection pulse P output from the vertical scanning circuit 12, from the vertical scanning circuit 12 to the q number of pixels 21 and supplies the transmitted row selection pulse P to the q number of pixels 21.

The q number of vertical signal line groups 23 correspond one-to-one to the q number of columns 32. Each vertical signal line group 23 included in the q number of vertical signal line groups 23 is electrically connected to the p number of pixels 21 belonging to the column 32 to which the vertical signal line group 23 corresponds, and each vertical signal line group 23 is electrically connected to the analog-to-digital conversion circuit 13. Each vertical signal line group 23 thus transmits an analog signal A, which indicates the amount of electric charge discharged by the pixel 21 included in the p number of pixels 21, from the pixel 21 to the analog-to-digital conversion circuit 13 and supplies the transmitted analog signal A to the analog-to-digital conversion circuit 13. The supplied analog signal A has a voltage corresponding to the intensity of the light received by the pixel 21. The greater the intensity of the light received by the pixel 21 is, the smaller the voltage of the analog signal A is. The greater the intensity of the light received by the pixel 21 is, the greater the absolute value of the voltage of the analog signal A is.

The vertical scanning circuit 12 scans the pixel unit 11 vertically. The vertical scanning circuit 12 selects an r number of row selection lines 22 simultaneously from the p number of row selection lines 22 and causes the r number of selected row selection lines 22 to transmit the row selection pulse P. The vertical scanning circuit 12 sequentially changes the r number of row selection lines 22 to be selected. In this embodiment, r is 16; further, r may be an integer equal to or greater than 4 and may be increased or decreased from 16.

Accordingly, the pixel unit 11 and the vertical scanning circuit 12 simultaneously supply, to the analog-to-digital conversion circuit 13, an r × q number of analog signals A, which indicate the amount of electric charge output by an r × q number of pixels 21 belonging to an r number of rows 31 selected from the p number of rows 31. That is, the imaging device 1 can read r rows simultaneously. The pixel unit 11 and the vertical scanning circuit 12 sequentially change the r number of rows 31 to be selected.

The analog-to-digital conversion circuit 13 converts the supplied r × q number of analog signals A into an r × q number of digital signals D individually and outputs the r × q number of digital signals D. The smaller the voltage of the r × q number of analog signals A is, the greater each of grayscale values, which are expressed by the r × q number of output digital signals D, is, and the greater the absolute value of the voltage of the r × q number of analog signals A is, the greater each grayscale value is.

The storage memory 14 stores the r × q number of output digital signals D. The storage memory 14 is formed from an r × q number of latches.

The transfer circuit 15 transfers the r × q number of stored digital signals D from the storage memory 14 to the correction circuit 16.

The correction circuit 16 performs correction on the r × q number of transferred digital signals D and outputs the corrected digital signals. The corrected digital signals constitute image signals.

The controller 17 controls the vertical scanning circuit 12, analog-to-digital conversion circuit 13, and correction circuit 16 to cause the vertical scanning circuit 12, analog-to-digital conversion circuit 13, and correction circuit 16 to preform operations that will be described below. The controller 17 is formed from an electronic circuit.

### 1.2 Simultaneous Readout of R Rows

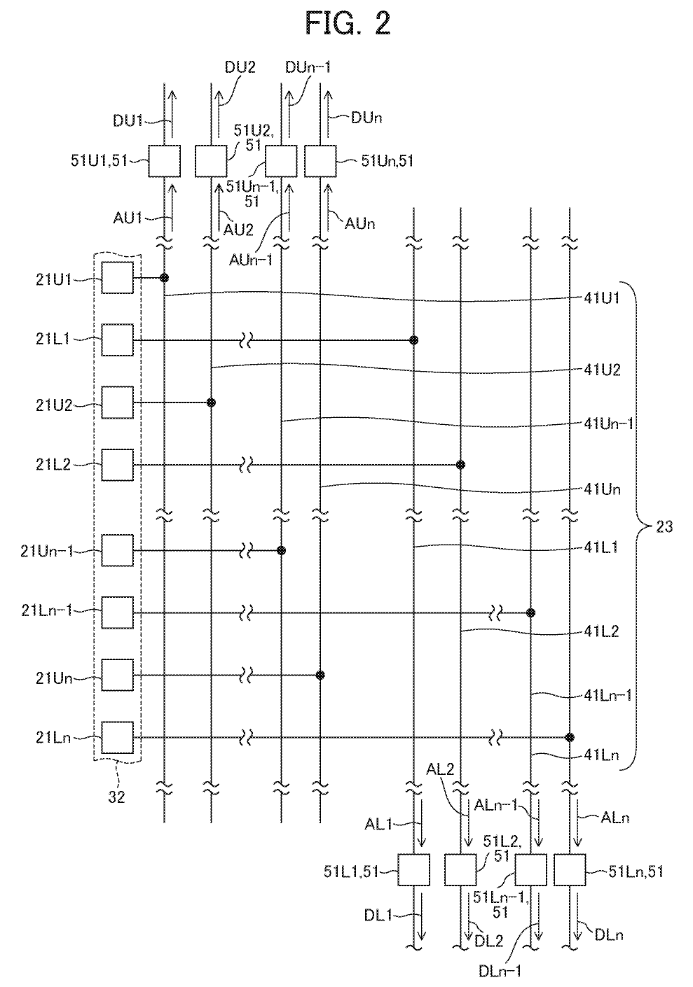

FIG. 2 is a block diagram of the columns, the vertical signal line groups, and first to n-th readout circuits provided in the imaging device according to the first embodiment.

As illustrated in FIG. 2, each vertical signal line group 23 includes first to n-th vertical signal lines 41U1, 41U2, ..., 41Un-1, and 41Un, and first to n-th vertical signal lines 41L1, 41L2, ..., 41Ln-1, and 41Ln. The analog-to-digital conversion circuit 13 includes first to n-th readout circuits 51U1, 51U2, ..., 51Un-1, and 51Un, and first to n-th readout circuits51L1, 51L2, ..., 51Ln-1, and 51Ln. In this embodiment, n is 8; further, n may be an integer equal to or greater than 2 and may be increased or decreased from 8.

The first to n-th vertical signal lines 41U1, 41U2, ..., 41Un-1, and 41U, which are included in each vertical signal line group 23, are electrically connected one-to-one to pixels 21U1, 21U2, ..., 21Un-1, and 21Un, which belong to respective first to n-th rows belonging to the column 32 to which the vertical signal line group 23 corresponds, and are electrically connected one-to-one to the first to n-th readout circuits 51U1, 51U2, ..., 51Un-1, and 51Un. The first to n-th vertical signal lines 41L1, 41L2, ..., 41Ln-1, and 41Ln, which are included in each vertical signal line group 23, are electrically connected one-to-one to pixels 21L1, 21L2, ..., 21Ln-1, and 21Ln, which belong to the respective first to n-th rows belonging to the column 32 to which the vertical signal line group 23 corresponds, and are electrically connected one-to-one to the first to n-th readout circuits 51L1, 51L2, ..., 51Ln-1, and 51Ln. The vertical signal lines 41U1, 41U2, ..., 41Un-1, and 41Un respectively transmit, from the pixels 21U1, 21U2, ..., 21Un-1, and 21Un to the readout circuits 51U1, 51U2, ..., 51Un-1, and 51Un, analog signals AU1, AU2, ..., AUn-1, and AUn, which indicate the amounts of electric charge discharged by the pixels 21U1, 21U2, ..., 21Un-1, and 21Un, in the first to n-th rows. The vertical signal lines 41U1, 41U2, ..., 41Un-1, and 41Un then respectively supply the transmitted analog signals AU1, AU2, ..., AUn-1, and AUn to the readout circuits 51U1, 51U2, ..., 51Un-1, and 51Un. The vertical signal lines 41L1, 41L2, ..., 41Ln-1, and 41Ln respectively transmit, from the pixels 21L1, 21L2, ..., 21Ln-1, and 21Ln to the readout circuits 51L1, 51L2, ..., 51Ln-1, and 51Ln, analog signals AL1, AL2, ..., ALn-1, and ALn, which indicate the amounts of electric charge discharged by the pixels 21L1, 21L2, ..., 21Ln-1, and 21Ln, in the first to n-th rows. The vertical signal lines 41L1, 41L2, ..., 41Ln-1, and 41Ln then respectively supply the transmitted analog signals AL1, AL2, ..., ALn-1, and ALn to the readout circuits 51L1, 51L2, ..., 51Ln-1, and 51Ln. Accordingly, the imaging device 1 can read r rows simultaneously.

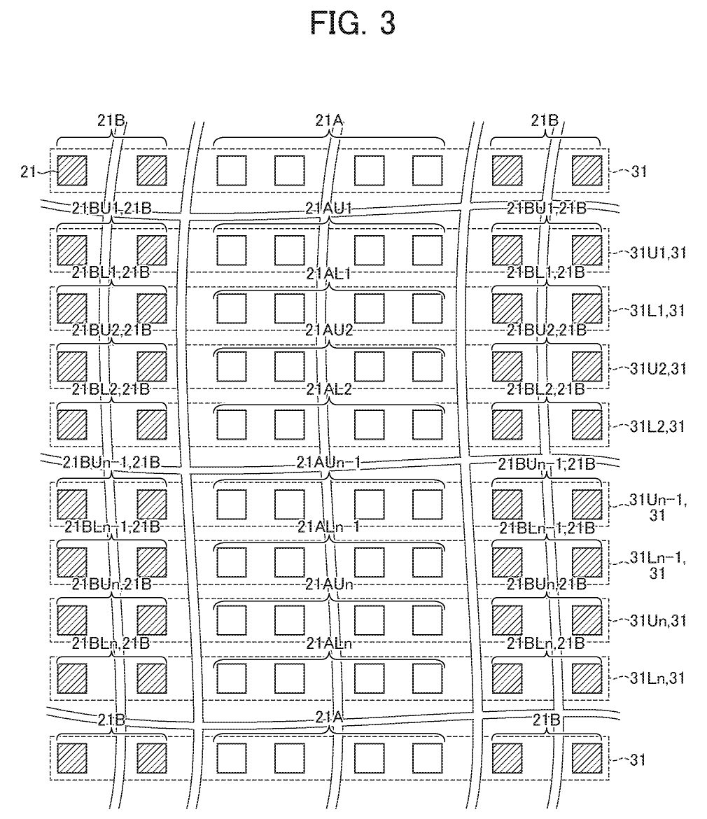

FIG. 3 is a schematic plan view of the p × q number of pixels provided in the imaging device according to the first embodiment.

The first to n-th readout circuits 51U1, 51U2, ..., 51Un-1, and 51Un simultaneously read the analog signals AU1, AU2, ..., AUn-1, and AUn in the first to n-th rows, respectively, from the pixels 21 belonging to first to n-th rows 31U1, 31U2, ..., 31Un-1, and 31Un included in the p number of rows 31 illustrated in FIG. 3. The first to n-th readout circuits 51L1, 51L2, ..., 51Ln-1, and 51Ln simultaneously read the analog signals AL1, AL2, ..., ALn-1, and ALn in the first to n-th rows, respectively, from the pixels 21 belonging to first to n-th rows 31L1, 31L2, ..., 31Ln-1, and 31Ln included in the p number of rows 31 illustrated in FIG. 3.

As illustrated in FIG. 1, the readout circuits 51U1, 51U2, ..., 51Un-1, and 51Un are arranged on the upper side of the pixel unit 11. The readout circuits 51L1, 51L2, ..., 51Ln-1, and 51Ln are arranged on the lower side of the pixel unit 11. Thus, the analog signals AU1, AU2, ..., AUn-1, and AUn read by the readout circuits 51U1, 51U2, ..., 51Un-1, and 51Un are transmitted upward. The analog signals AL1, AL2, ..., ALn-1, and ALn read by the readout circuits 51L1, 51L2, ..., 51Ln-1, and 51Ln are transmitted downward. This arrangement, that is, the readout circuits 51U1, 51U2, ..., 51Un-1, and 51Un and the readout circuits 51L1, 51L2, ..., 51Ln-1, and 51Ln are arranged separately on both of the upper and lower sides of the pixel unit 11, can increase the number of readout circuits that can be arranged, and can thus increase the number of rows 31 that can be simultaneously read. However, the readout circuits may be arranged collectively, only one of the upper and lower sides of the pixel unit 11.

### 1.3 Analog-To-Digital Conversion

As illustrated in FIG. 1, the analog-to-digital conversion circuit 13 includes a ramp circuit 52U and a ramp circuit 52L.

The ramp circuit 52U inputs a common ramp voltage RU to the readout circuits 51U1, 51U2, ..., 51Un-1, and 51Un. The ramp circuit 52L inputs a common ramp voltage RL to the readout circuits 51L1, 51L2, ..., 51Ln-1, and 51Ln.

As illustrated in FIGS. 1 and 2, the readout circuits 51U1, 51U2, ..., 51Un-1, and 51Un convert the analog signals AU1, AU2, ..., AUn-1, and AUn into digital signals DU1, DU2, ..., DUn-1, and DUn, respectively, in accordance with the timing at which the voltage of the read analog signals AU1, AU2, ..., AUn-1, and AUn, and the input common ramp voltage RU are inverted in level. The readout circuits 51L1, 51L2, ..., 51Ln-1, and 51Ln convert the analog signals AL1, AL2, ..., ALn-1, and ALn into digital signals DL1, DL2, ..., DLn-1, and DLn, respectively, in accordance with the timing at which the voltage of the read analog signals AL1, AL2, ..., ALn-1, and ALn, and the input common ramp voltage RL are inverted in level.

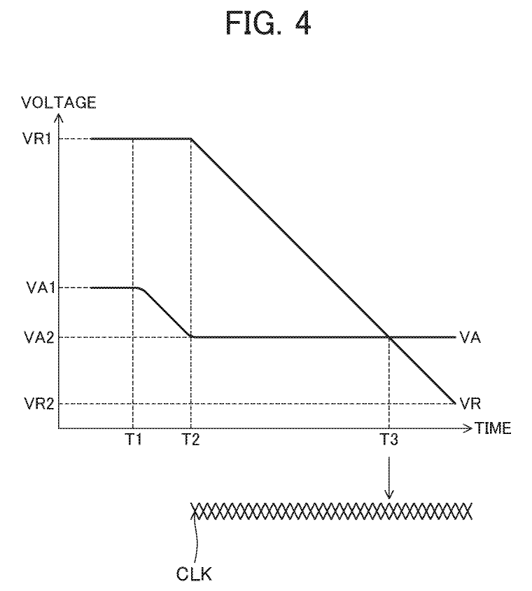

FIG. 4 is a timing chart showing the waveform of analog signal voltage read by each readout circuit, which is provided in the imaging device according to the first embodiment, the waveform of ramp voltage input to the readout circuit, and clocks counted by the readout circuit. In the timing chart of FIG. 4, the lateral axis indicates time, and the longitudinal axis indicates voltage.

As shown in FIG. 4, a voltage VA of the analog signal read by each readout circuit 51, i.e., each of the read circuits 51U1, 51U2, ..., 51Un-1, and 51Un, and the readout circuits 51L1, 51L2, ..., 51Ln-1, and 51Ln, decreases from an initial voltage VA1 to a voltage VA2, which corresponds to the amount of electric charge discharged by the pixel 21, in response to a reset of the pixel 21 for which the analog signal is read, to a timing T1.

A ramp voltage VR input to each readout circuit 51 decreases from a starting voltage VR1 to a termination voltage VR2 at a constant time change rate in response to the start of counting the number of clocks CLK at a timing T2 by the readout circuit 51.

At a timing T3 of drop of the readout circuit VR to the voltage VA2, each readout circuit 51 latches the counted number of clocks CLK and outputs a digital signal D having a signal value corresponding to the number of latched clocks CLK. The number of latched clocks CLK increases as the time from the timing T2 to timing T3 becomes longer and increases as the voltage VA2 becomes lower. Thus, the number of latched clocks CLK increases along with increase in the amount of electric charge discharged by the pixel 21. Thus, the output digital signal D has a signal value corresponding to the amount of discharged electric charge.

### 1.4 Effective Pixels and Optical Black Pixels

As illustrated in FIG. 3, the q number of pixels 21 belonging to each row 31 include a u number of effective pixels 21A and a v number of optical black (OB) pixels 21B. In this embodiment, u is 2560, and v is 32; further, u may be increased or decreased from 2560, and v may be increased or decreased from 32.

Each effective pixel 21A included in the u number of effective pixels 21A is configured in such a manner that light reached the effective pixel 21A is incident on a photodiode provided in the effective pixel 21A. Thus, an analog effective pixel signal corresponding to the intensity of the light reached each effective pixel 21A is read out of the effective pixel 21A.

Each OB pixel 21B included in the v number of OB pixels 21B is configured in such a manner that light reached the OB pixel 21B and blocked to thus reach the OB pixel 21B is not incident on a photodiode provided in the OB pixel 21B. Thus, an analog OB pixel signal indicating black level is read out of each OB pixel 21B.

The u number of effective pixels 21A and the v number of OB pixels 21B are arranged horizontally. Thus, the v number of OB pixels 21B are horizontal optical black (HOB) pixels. The v number of OB pixels 21B are arranged separately on both sides of the u number of effective pixels 21A. The v number of OB pixels 21B may be arranged collectively, only one of the sides of the u number of effective pixels 21A.

As earlier described, the q number of pixels 21 belonging to each row 31 include the u number of effective pixels 21A and the v number of OB pixels 21B. Thus, the first to n-th rows 31U1, 31U2, ..., 31Un-1, and 31Un that are read at the same time include effective pixels 21AU1, 21AU2, ..., 21AUn-1, and 21AUn, respectively, and OB pixels 21BU1, 21BU2, ..., 21BUn-1, and 21BUn, respectively. The first to n-th rows 31L1, 31L2, ..., 31Ln-1, and 31Ln that are read at the same time include effective pixels 21AL1, 21AL2, ..., 21ALn-1, and 21ALn, respectively, and OB pixels 21BL1, 21BL2, ..., 21BLn-1, and 21BLn, respectively.

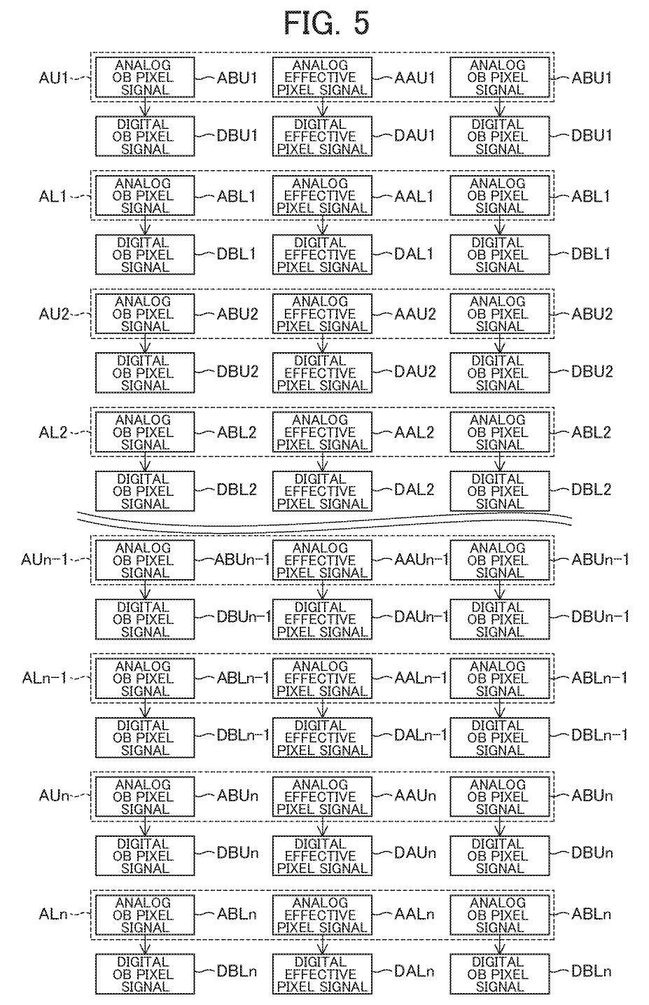

FIG. 5 is a diagram illustrating the analog effective pixel signals, analog OB pixel signals, digital effective pixel signals, and digital OB pixel signals that are processed by the imaging device according to the first embodiment.

As illustrated in FIG. 5, the analog signals AU1, AU2, …, AUn-1, and AUn in the first to n-th rows 31U1, 31U2, …, 31Un-1, and 31Un, which are read by the first to n-th readout circuits 51U1, 51U2, …, 51Un-1, and 51Un, respectively include analog effective pixel signals AAU1, AAU2, …, AAUn-1, and AAUn in the first to n-th rows 31U1, 31U2, ..., 31Un-1, and 31Un, which are read out of the effective pixels 21AU1, 21AU2, ..., 21AUn-1, and 21AUn. These analog signals AU1, AU2, …, AUn-1, and AUn also respectively include analog OB pixel signals ABU1, ABU2, …, ABUn-1, and ABUn in the first to n-th rows 31U1, 31U2, …, 31Un-1, and 31Un, which are read out of the OB pixels 21BU1, 21BU2, ..., 21BUn-1, and 21BUn. The analog signals AL1, AL2, ..., ALn-1, and ALn in the first to n-th rows 31L1, 31L2, ..., 31Ln-1, and 31Ln, which are read by the first to n-th readout circuits 51L1, 51L2, ..., 51Ln-1, and 51Ln, respectively include analog effective pixel signals AAL1, AAL2, ..., AALn-1, and AALn in the first to n-th rows 31L1, 31L2, ..., 31Ln-1, and 31Ln, which are read out of the effective pixels 21AL1, 21AL2, ..., 21ALn-1, and 21ALn. These analog signals AL1, AL2, …, ALn-1, and ALn also respectively include analog OB pixel signals ABL1, ABL2, ..., ABLn-1, and ABLn in the first to n-th rows 31L1, 31L2, ..., 31Ln-1, and 31Ln, which are read out of the OB pixels 21BL1, 21BL2, ..., 21BLn-1, and 21BL.

The readout circuits 51U1, 51U2, …, 51Un-1, and 51Un simultaneously read the analog effective pixel signals AAU1, AAU2, …, AAUn-1, and AAUn, and the analog OB pixel signals ABU1, ABU2, …, ABUn-1, and ABUn. The readout circuits 51L1, 51L2, ..., 51Ln-1, and 51Ln simultaneously read the analog effective pixel signals AAL1, AAL2, ..., AALn-1, and AALn, and the analog OB pixel signals ABL1, ABL2, ..., ABLn-1, and ABLn.

The readout circuits 51U1, 51U2, ..., 51Un-1, and 51Un respectively convert the analog effective pixel signals AAU1, AAU2, ..., AAUn-1, and AAUn into digital effective pixel signals DAU1, DAU2, ..., DAUn-1, and DAUn in the first to n-th rows 31U1, 31U2, ..., 31Un-1, and 31Un, in accordance with the timing at which the voltage of the read analog effective pixel signals AAU1, AAU2, ..., AAUn-1, and AAUn, and the input common ramp voltage RU are inverted in level. The readout circuits 51U1, 51U2, ..., 51Un-1, and 51Un respectively convert the analog OB pixel signals ABU1, ABU2, ..., ABUn-1, and ABUn into digital OB pixel signals DBU1, DBU2, ..., DBUn-1, and DBUn in the first to n-th rows 31U1, 31U2, ..., 31Un-1, and 31Un, in accordance with the timing at which the voltage of the read analog OB pixel signals ABU1, ABU2, ..., ABUn-1, and ABUn, and the input common ramp voltage RU are inverted in level. The readout circuits 51L1, 51L2, ..., 51Ln-1, and 51Ln respectively convert the analog effective pixel signals AAL1, AAL2, ..., AALn-1, and AALn into digital effective pixel signals DAL1, DAL2, ..., DALn-1, and DALn in the first to n-th rows 31L1, 31L2, ..., 31Ln-1, and 31Ln, in accordance with the timing at which the voltage of the read analog effective pixel signals AAL1, AAL2, ..., ALn-1, and AALn, and the input common ramp voltage RL are inverted in level. The readout circuits 51L1, 51L2, ..., 51Ln-1, and 51Ln respectively convert the analog OB pixel signals ABL1, ABL2, ..., ABLn-1, and ABLn into digital OB pixel signals DBL1, DBL2, ..., DBLn-1, and DBLn in the first to n-th rows 31L1, 31L2, ..., 31Ln-1, and 31Ln, in accordance with the timing at which the voltage of the read analog OB pixel signals ABL1, ABL2, ..., ABLn-1, and ABLn, and the input common ramp voltage RL are inverted in level.

### 1.5 Correction

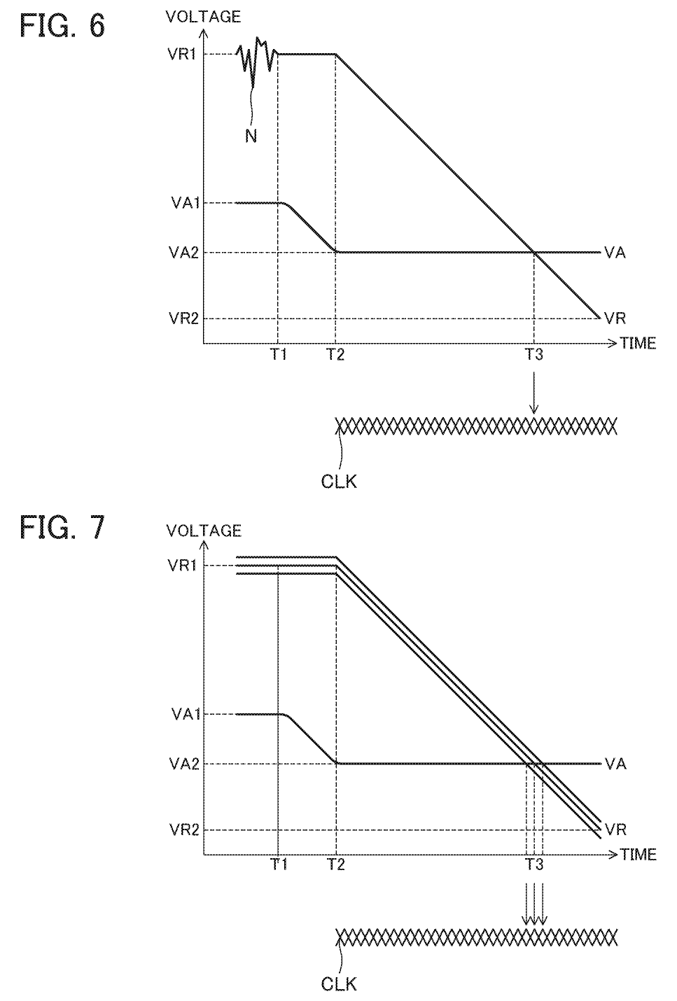

FIG. 6 is a timing chart showing the waveform of analog signal voltage read by each readout circuit, which is provided in the imaging device according to the first embodiment, the actual waveform of ramp voltage input to the readout circuit, and clocks counted by the readout circuit. FIG. 7 is a timing chart showing the waveform of analog signal voltage read by each readout circuit, which is provided in the imaging device according to the first embodiment, the waveforms of three kinds of ramp voltage that can be input to the readout circuit, and clocks counted by the readout circuit. In the timing charts of FIGS. 6 and 7, the lateral axis indicates time, and the longitudinal axis indicates voltage.

As shown in FIG. 6, the ramp voltage VR input to each readout circuit 51 includes a noise component N overlapping a signal component. The noise component N causes an offset of the starting voltage VR1 of the ramp voltage VR. Thus, the starting voltage VR1 varies, as shown in FIG. 7. Thus, the timing T3 of level inversion between the voltage VA of the analog signal A, which is read by each readout circuit 51, and the ramp voltage VR, which is input to the readout circuit 51, varies. Thus, the number of clocks CLK that is latched by each readout circuit 51 varies.

The correction circuit 16 performs correction for preventing the influence of the variation in the number of latched clocks CLK. To this end, the correction circuit 16 corrects, by using the digital OB pixel signals DBU1, DBU2, ..., DBUn-1, and DBUn, the digital effective pixel signals DAU1, DAU2, ..., DAUn-1, and DAUn obtained by using the common ramp voltage RU, and the correction circuit 16 also corrects, by using the digital OB pixel signals DBL1, DBL2, ..., DBLn-1, and DBLn, the digital effective pixel signals DAL1, DAL2, …, DALn-1, and DALn obtained by using the common ramp voltages RL. The correction circuit 16 thus enhances the quality of a video represented by the output image signals, to thus enhance imaging quality.

The correction circuit 16 corrects, by using the digital OB pixel signals DBU1, DBU2, ..., DBUn-1, and DBUn, the digital effective pixel signal in each of the first to n-th rows 31U1, 31U2, ..., 31Un-1, and 31Un, which is each of the digital effective pixel signals DAU1, DAU2, ..., DAUn-1, and DAUn. The correction circuit 16 corrects, by using the digital OB pixel signals DBL1, DBL2, ..., DBLn-1, and DBLn, the digital effective pixel signal in each of the first to n-th rows 31L1, 31L2, ..., 31Ln-1, and 31Ln, which is each of the digital effective pixel signals DAL1, DAL2, ..., DALn-1, and DALn. The correction circuit 16 can thus correct a u number of digital effective pixel signals that are obtained from the u number of effective pixels 21A belonging to a single row 31 by using an n × v number of digital OB pixel signals that are obtained from an n × v number of OB pixels 21B belonging to an n number of rows 31 that are read simultaneously. This can increase the number of OB pixels 21B for use in the correction and can thus enhance correction accuracy when compared to an instance where the correction circuit 16 corrects, by using the v number of digital OB pixel signals that are obtained from the v number of OB pixels 21B belonging to a single row 31, the u number of digital effective pixel signals that are obtained from the u number of effective pixels belonging to the same single row 31. Accordingly, the number of OB pixels 21B belonging to a single row 31 can be reduced without degrading the correction accuracy. Consequently, both of the enhancement of the imaging quality and the reduction of the area occupied by the pixel unit 11 can be achieved.

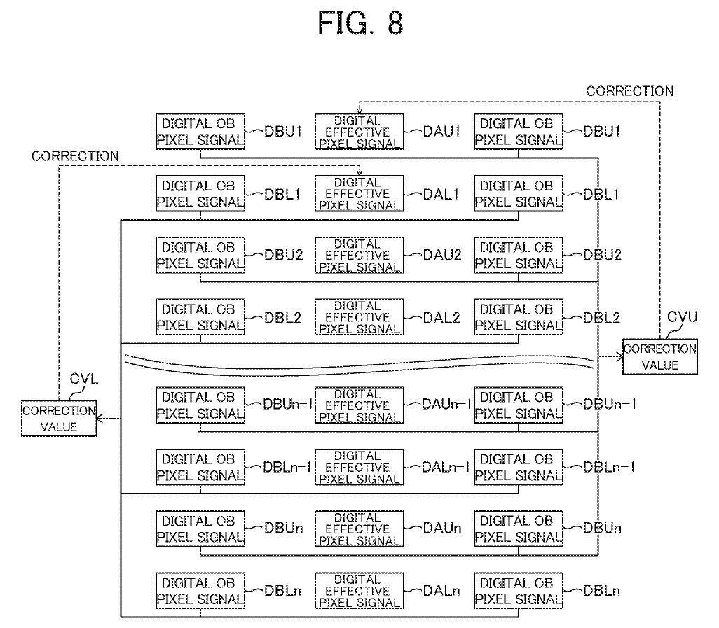

FIG. 8 is a diagram illustrating an example correction made by the correction circuit provided in the imaging device according to the first embodiment.

As illustrated in FIG. 8, the correction circuit 16, when correcting the digital effective pixel signal in each of the first to n-th rows 31U1, 31U2, ..., 31Un-1, and 31Un (e.g., the digital effective pixel signal DAU1 in the first row 31U1) by using the digital OB pixel signals DBU1, DBU2, ..., DBUn-1, and DBUn, determines a correction value CVU from the digital OB pixel signals DBU1, DBU2, ..., DBUn-1, and DBUn and corrects the digital effective pixel signal in each of the rows by using the determined correction value CVU. The correction circuit 16, when correcting the digital effective pixel signal in each of the first to n-th rows 31L1, 31L2, ..., 31Ln-1, and 31Ln (e.g., the digital effective pixel signal DAL1 in the first row 31L1) by using the digital OB pixel signals DBL1, DBL2, ..., DBLn-1, and DBLn, determines a correction value CVL from the digital OB pixel signals DBL1, DBL2, ..., DBLn-1, and DBLn and corrects the digital effective pixel signal in each of the rows by using the determined correction value CVL. The correction values CVU and CVL are average values, median values, or other values. The correction circuit 16, when correcting the digital effective pixel signal in each of the first to n-th rows 31U1, 31U2, ..., 31Un-1, and 31Un by using the correction value CVU, subtracts, for instance, the correction value CVU from a signal value represented by the digital effective pixel signal in the row. The correction circuit 16, when correcting the digital effective pixel signal in each of the first to n-th rows 31L1, 31L2, ..., 31Ln-1, and 31Ln by using the correction value CVL, subtracts, for instance, the correction value CVL from a signal value represented by the digital effective pixel signal in the row. This can prevent a lateral noise in the video represented by the output image signals.

### 1.6 Storage Memory And Transfer Circuit

The following describes storing and transferring the digital effective pixel signals DAU1, DAU2, ..., DAUn-1, and DAUn, and digital OB pixel signals DBU1, DBU2, ..., DBUn-1, and DBUn obtained from the first to n-th rows 31U1, 31U2, ..., 31Un-1, and 31Un. Storing and transferring the digital effective pixel signals DAL1, DAL2, ..., DALn-1, and DALn, and digital OB pixel signals DBL1, DBL2, ..., DBLn-1, and DBLn obtained from the first to n-th rows 31L1, 31L2, ..., 31Ln-1, and 31Ln are also performed in a manner similar to that in storing and transferring the digital effective pixel signals DAU1, DAU2, ..., DAUn-1, and DAUn, and digital OB pixel signals DBU1, DBU2, ..., DBUn-1, and DBUn obtained from the first to n-th rows 31U1, 31U2, ..., 31Un-1, and 31Un.

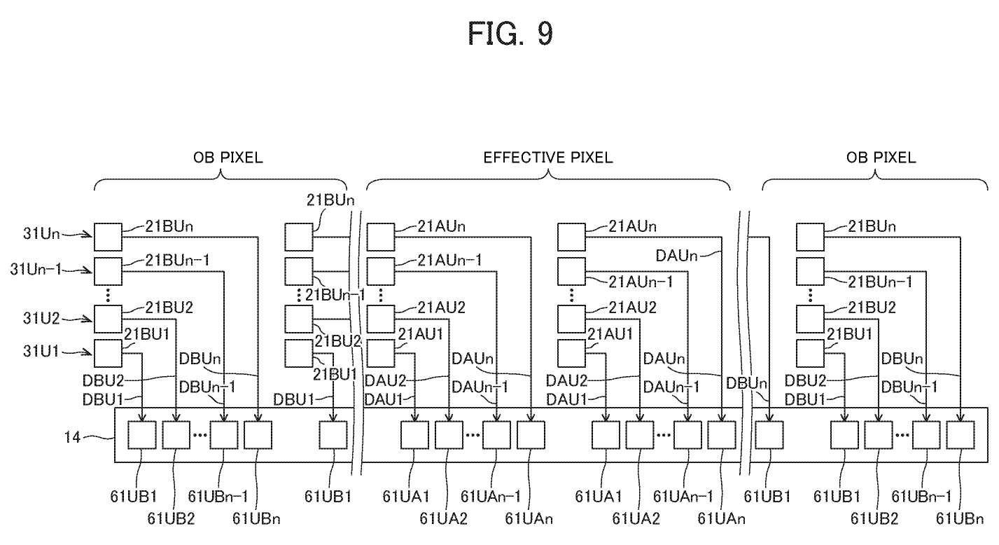

FIG. 9 is a block diagram of the first to n-th rows and storage memory provided in the imaging device according to the first embodiment.

In FIG. 9, the effective pixel belonging to the first row 31U1 is an effective pixel 21AU1, and the OB pixel belonging to the first row 31U1 is an OB pixel 21BU1. The effective pixel belonging to the second row 31U2 is an effective pixel 21AU2, and the OB pixel belonging to the second row 31U2 is an OB pixel 21BU2, ..., the effective pixel belonging to the n-1-th row 31Un-1 is an effective pixel 21AUn-1, and the OB pixel belonging to the n-1-th row 31Un-1 is an OB pixel 21BUn-1. The effective pixel belonging to the n-th row 31Un is an effective pixel 21AUn, and the OB pixel belonging to the n-th row 31Un is an OB pixel 21BUn. As illustrated in FIG. 9, the storage memory 14 includes effective-pixel latches 61UA1, 61UA2, ..., 61UAn-1, and 61UAn that are for n rows, and that store the digital effective pixel signals DAU1, DAU2, ..., DAUn-1, and DAUn obtained from the effective pixels 21AU1, 21AU2, ..., 21AUn-1, and 21AUn, which belong to the first to n-th rows 31U1, 31U2, ..., 31Un-1, and 31Un. The storage memory 14 also includes OB-pixel latches 61UB1, 61UB2, ..., 61UBn-1, and 61UBn that are for the n rows, and that store the digital OB pixel signals DBU1, DBU2, ..., DBUn-1, and DBUn obtained from the OB pixels 21BU1, 21BU2, ..., 21BUn-1, and 21BUn, which belong to the first to n-th rows 31U1, 31U2, ..., 31Un-1, and 31Un.

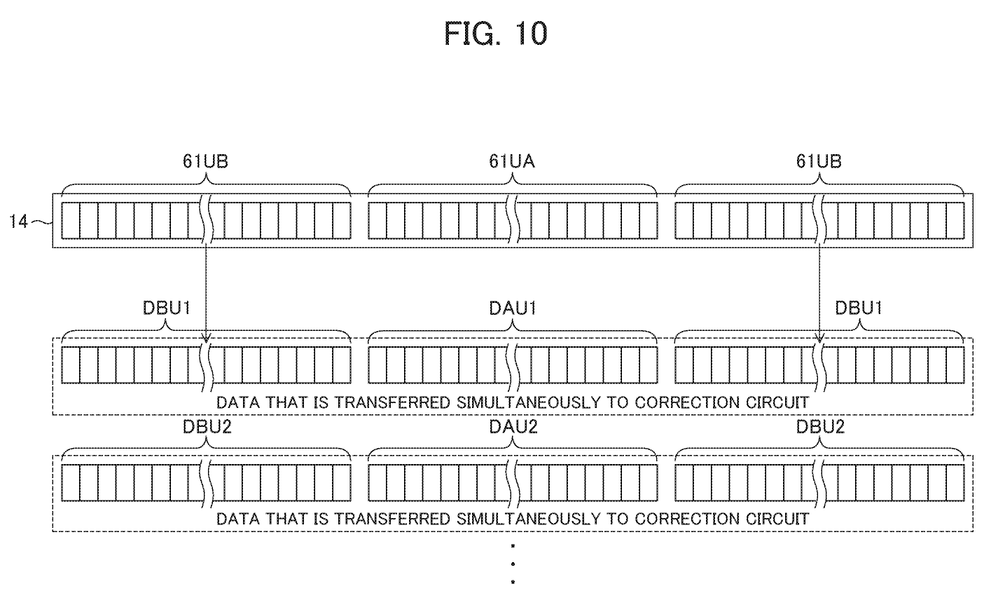

FIG. 10 is a diagram of a storage memory provided in an imaging device according to a reference example, and of digital effective pixel signals and digital OB pixel signals that are transferred by a transfer circuit provided in the imaging device.

In the imaging device according to the reference example, the storage memory 14 includes only the effective-pixel latch 61UA and OB-pixel latch 61UB for a single row, as illustrated in FIG. 10. Further, the first to n-th rows 31U1, 31U2, ..., 31Un-1, and 31Un are sequentially selected one by one in the stated order. Further, the following process steps (1), (2), ..., (n-1), and (n) are sequentially performed one by one in the stated order:
(1) The digital effective pixel signal DAU1 and digital OB pixel signal DBU1 obtained from the first row 31U1 are stored in the storage memory 14, and the stored digital effective pixel signal DAU1 and digital OB pixel signal DBU1 are simultaneously transferred to the correction circuit 16;
(2) The digital effective pixel signal DAU2 and digital OB pixel signal DBU2 obtained from the second row 31U2 are stored in the storage memory 14, and the stored digital effective pixel signal DAU2 and digital OB pixel signal DBU2 are simultaneously transferred to the correction circuit 16;
...
(n-1) The digital effective pixel signal DAUn-1 and digital OB pixel signal DBUn-1 obtained from the n-1-th row 31Un-1 are stored in the storage memory 14, and the stored digital effective pixel signal DAUn-1 and digital OB pixel signal DBUn-1 are simultaneously transferred to the correction circuit 16; and
(n) The digital effective pixel signal DAUu and digital OB pixel signal DBUn obtained from the n-th row 31Un are stored in the storage memory 14, and the stored digital effective pixel signal DAUn and digital OB pixel signal DBUn are simultaneously transferred to the correction circuit 16.

In the imaging device according to the reference example, a digital OB pixel signal that is transferred simultaneously with a digital effective pixel signal obtained from a specific row includes a digital OB pixel signal obtained from the specific row, but does not include digital OB pixel signals obtained from rows other than the specific row.

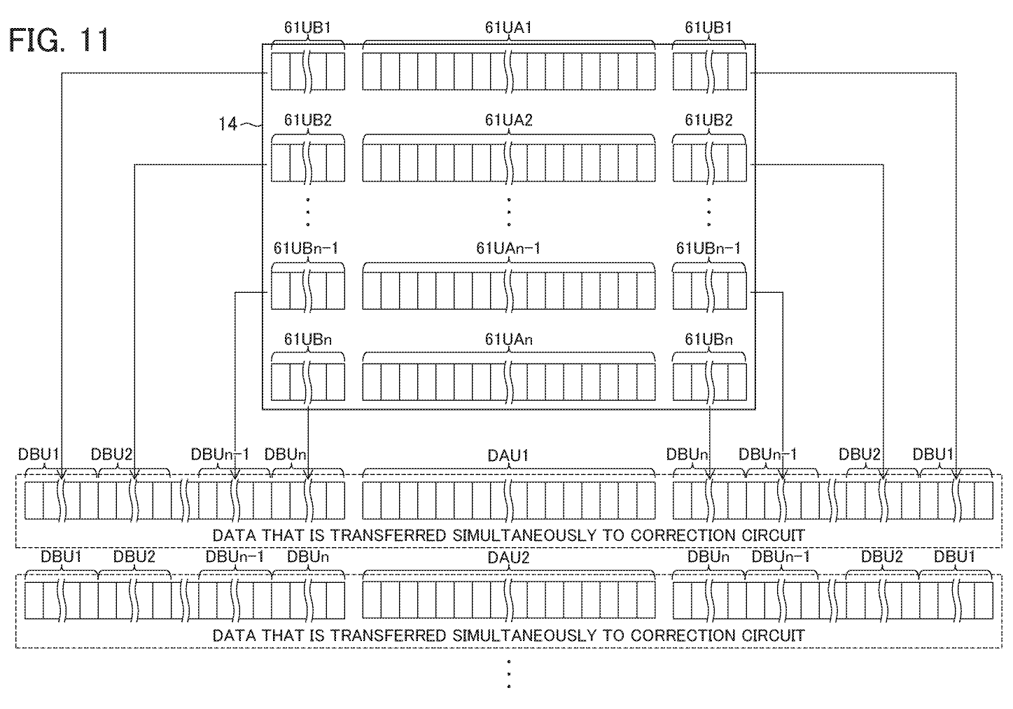

FIG. 11 is a diagram of the storage memory provided in the imaging device according to the first embodiment, and of the digital effective pixel signals and digital OB pixel signals that are transferred by the transfer circuit provided in the imaging device.

In the imaging device 1 according to the first embodiment, the storage memory 14 includes the effective-pixel latches 61UA1, 61UA2, ..., 61UAn-1, and 61UAn for the n rows, and the OB-pixel latches 61UB1, 61UB2, ..., 61UBn-1, and 61UBn for the n rows, as illustrated in FIG. 11. Further, the first to n-th rows 31U1, 31U2, ..., 31Un-1, and 31Un are simultaneously selected collectively. Further, the following process steps (1), (2), ..., (n), and (n+1) are sequentially performed one by one in the stated order:
(1) The digital effective pixel signals DAU1, DAU2, ..., DAUn-1, and DAUn and digital OB pixel signals DBU1, DBU2, ..., DBUn-1, and DBUn obtained from the first to n-th rows 31U1, 31U2, ..., 31Un-1, and 31Un are stored in the storage memory 14;
(2) The stored digital effective pixel signal DAU1 and digital OB pixel signals DBU1, DBU2, ..., DBUn-1, and DBUn are simultaneously transferred to the correction circuit 16;
(3) The stored digital effective pixel signal DAU2 and digital OB pixel signals DBU1, DBU2, ..., DBUn-1, and DBUn are simultaneously transferred to the correction circuit 16;
...
(n) The stored digital effective pixel signal DAUn-1 and digital OB pixel signals DBU1, DBU2, ..., DBUn-1, and DBUn are simultaneously transferred to the correction circuit 16; and
(n+1) The stored digital effective pixel signal DAUn and digital OB pixel signals DBU1, DBU2, ..., DBUn-1, and DBUn are simultaneously transferred to the correction circuit 16.

In the imaging device according to the first embodiment, a digital OB pixel signal that is transferred simultaneously with a digital effective pixel signal obtained from a specific row includes a digital OB pixel signal obtained from the specific row and further includes digital OB pixel signals obtained from rows other than the specific row. Consequently, when a digital effective pixel signal obtained from a specific row is transferred, a digital OB pixel signal necessary for correcting the transferred digital effective pixel signal can be transferred simultaneously. This can correct the transferred digital effective pixel signal without providing, in the correction circuit 16, a memory that stores digital OB pixel signals.

The present disclosure is not limited to the above-described embodiment. The present disclosure may be replaced with a configuration substantially identical to those described in the above-described embodiments, a configuration that provides the same action and effect as those described in the above-described embodiments, or a configuration that achieves the same object as those described in the above-described embodiments.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An imaging device comprising:
first to n-th rows each including an effective pixel and an optical black pixel;
first to n-th readout circuits configured to
read analog effective pixel signals in the first to n-th rows, respectively, from the effective pixels belonging to the first to n-th rows,
read analog optical black pixel signals in the first to n-th rows, respectively, from the optical black pixels belonging to the first to n-th rows,
convert the analog effective pixel signals in the first to n-th rows into digital effective pixel signals in the first to n-th rows, and
convert the analog optical black pixel signals in the first to n-th rows into digital optical black pixel signals in the first to n-th rows, respectively; and
a correction circuit configured to correct the digital effective pixel signal in each of the first to n-th rows by using the digital optical black pixel signals in the first to n-th rows.

2. The imaging device according to claim 1, wherein the first to n-th readout circuits simultaneously read the analog effective pixel signals in the first to n-th rows, and the analog optical black pixel signals in the first to n-th rows.

3. The imaging device according to claim 1, comprising a ramp circuit configured to input a common ramp voltage to the first to n-th readout circuits,
wherein the first to n-th readout circuits
convert the analog effective pixel signals in the first to n-th rows into the digital effective pixel signals in the first to n-th rows, respectively, in accordance with a timing at which a voltage of the analog effective pixel signals in the first to n-th rows and the common ramp voltage are inverted in level, and
convert the analog optical black pixel signals in the first to n-th rows into the digital optical black pixel signals in the first to n-th rows, respectively, in accordance with a timing at which a voltage of the analog optical black pixel signals in the first to n-th rows and the common ramp voltage are inverted in level.

4. The imaging device according to claim 1, wherein
correcting the digital effective pixel signal in each of the first to n-th rows by using the digital optical black pixel signals in the first to n-th rows includes
determining a correction value from the digital optical black pixel signals in the first to n-th rows, and
correcting the digital effective pixel signal in each of the first to n-th rows by using the correction value.

5. The imaging device according to claim 4, comprising:
a storage memory configured to store the digital effective pixel signals in the first to n-th rows, and the digital optical black pixel signals in the first to n-th rows; and
a transfer circuit configured to transfer, from the storage memory to the correction circuit, the digital optical black pixel signals in the first to n-th rows, simultaneously with transferring, from the storage memory to the correction circuit, the digital effective pixel signal in each of the first to n-th rows.
